(19) United States
(12) Patent Application Publication
(10) Pub. No.: US 2021/0129214 A1
(43) Pub. Date: May 6, 2021

(54) METAL ADDITIVE MANUFACTURING DEVICE

(71) Applicant: Shanghai Jiao Tong University, Shanghai (CN)

(72) Inventors: Lin Gu, Shanghai (CN); Wansheng Zhao, Shanghai (CN)

(73) Assignee: Shanghai Jiao Tong University, Shanghai (CN)

(21) Appl. No.: 16/723,516

(22) Filed: Dec. 20, 2019

(30) Foreign Application Priority Data
Oct. 30, 2019 (CN) 201911042742.X

(51) Int. Cl. B22D 23/00; B33Y 30/00

(52) U.S. Cl. CPC B22D 23/003; B33Y 30/00

(57) ABSTRACT

A metal additive manufacturing device is disclosed herein. The wire feeding mechanism in the protective bin can convey metal wires towards the substrate, the working medium filtration and circulation module conveys working mediums into the protective bin and discharges working mediums, the working medium between the metal wire and the substrate or between two metal wires is broken down, and plasma is generated and maintained; and under the action of high temperature of the plasma, the metal wires quickly melt to form the metal droplets. The rotating shaft drives the rotating arm to rotate. The working bin modules are disposed at both ends of the rotating arm. The droplets formed by the melting of the metal wires fly away from a melting area under the action of a centrifugal force, and the droplets reach the substrate or the surface of a machined workpiece, cool and solidify, and crystallize.

### CROSS-REFERENCE TO RELATED APPLICATIONS

This application claims the benefit of and priority to Chinese Patent Application No. CN 201911042742.X, entitled “METAL ADDITIVE MANUFACTURING DEVICE,” which was filed on Oct. 30, 2019. The entirety of Chinese Patent Application No. CN 201911042742.X is incorporated herein by reference as if set forth fully herein.

### FIELD

The disclosed subject matter relates to the technical field of additive manufacturing and peripheral supporting facilities thereof, and in particular to a metal additive manufacturing device.

### BACKGROUND

Additive manufacturing (also known as 3D printing) is an advanced manufacturing technology popular in recent years. Its principle is to melt filamentous or powdered raw materials, stack the raw materials along a predetermined track and cool the raw materials to form parts with three-dimensional shapes. Arc additive manufacturing uses heat generated by the arc to realize the melting of metal materials and is used for stacking to form parts. Parts obtained by arc or laser additive manufacturing are prone to defects such as porosity, shrinkage cavity and low fusion degree, and have problems such as low strength, which seriously affect the performance and service time of the parts. In addition, in microgravity environments such as space stations, molten metal or resin materials can hardly adhere to printed surfaces due to surface tension, which also brings insurmountable difficulties to the manufacturing process.

In order to solve the problems of air holes, strength and the like, researchers in China and other countries have proposed methods including rolling (CN108637504A), ultrasonic compounding (CN108067705A), vibration (CN105458264A) or laser shock (CN107283059A), laser-induced arc additive, hammer-strengthened arc additive (CN108340047A), arc shape control by an external magnetic field (CN108213649A) and the like on printed surfaces, and improved the performance by using a heat treatment process. The foregoing methods all require the addition of new devices, adding complexity to systems and making quality control more difficult.

The patent with the publication number CN105479741A provides a 3D printing system for a space environment. A rotary bin with 4 three-dimensional cavities implements gravity, control is performed by adopting an industrial PC, and the system includes a dust collection device and a mechanical hand for taking workpieces. A fusible material is heated by a heating device to achieve 3D printing. The materials used include wax, acrylonitrile butadiene styrene (ABS), polylactic acid (PLA), nylon, and the like, which are all nonmetallic materials. However, a method for additive manufacturing of metal materials and a method for additive manufacturing of nonmetal materials are completely different. The additive manufacturing of the materials such as the ABS and the PLA is essentially a thermoplastic reaction. The materials undergo a relatively simple physical process of melting, extrusion, forming and cooling. The heating temperature is only 200-300° C., and the heating means used are usually resistance-type heating heads. However, the metal additive manufacturing uses high-temperature heat sources such as laser, arc and electron beam (the temperature reaches thousands of degrees centigrade or even higher). The metal materials undergo the process of melting (liquefaction)-stacking-cooling crystallization. At this stage, metal atoms are rearranged and combined to form crystals. If two or more materials are used for printing, an alloying process is accompanied, which is far more complicated, more difficult and less controllable than a nonmetal 3D printing process.

The patent with the authorization publication number CN206749066U proposes a 3D printer auxiliary device used in a microgravity environment. The auxiliary device generates gravity by adopting a base with a bearing frame, a rotating beam with a free end provided with a 3D printer fixing box and a driving mechanism installed on the base and used for driving the rotating beam to rotate. The driving method is that a driving motor is in transmission connection with a power shaft through a belt transmission system, which mainly takes a fused deposition modeling (FDM) type 3D printer as an application object, and processed materials are also nonmetal.

The patent with the publication number CN108637504A provides an electric arc wire filling and rolling combined material additive manufacturing method, which can be used for additive manufacturing of metal materials. As the rolling method is adopted immediately after the arc material adding, the forming quality of parts can be effectively improved, air holes and shrinkage porosity can be reduced, and thus the comprehensive mechanical properties of metal materials can be enhanced. The method needs to add a rolling mechanism and rapidly apply a rolling force to the formed material, which has high control requirements and requires a large device operation space.

The patent with the publication number CN107283059A provides an electric arc fused deposition laser shock forging additive manufacturing method, with an objective of refining crystal grains also by utilizing the impact of laser, improving the forming quality of parts and reducing internal defects. However, the method needs to introduce a laser head with higher cost, and has complicated process and poor controllability.

The existing arc additive manufacturing technology adopts arc to heat metal wires or metal powder to melt the metal wires or the metal powder, and then make the metal wires or the metal powder fall on a working platform by gravity, and forming is performed by controlling tracks to be superposed layer by layer. According to the method, normal printing cannot be realized under a microgravity environment due to surface tension of metal droplets, and defects such as air holes, shrinkage porosity and the like are also caused in a ground environment due to a small amount of medium contained internally, so that the quality and mechanical properties of printed workpieces cannot reach the forging level. Existing patents for realizing printing through centrifugation are all used for manufacturing nonmetallic materials, and lack arc additive manufacturing and realizing solutions. The micro-forging effect is achieved by applying an external force such as rolling and laser shock to workpieces after material adding, which can improve the quality of the workpieces to a certain extent and reduce defects such as internal air holes. However, this method still cannot implement printing in weightlessness on the one hand, and increases the complexity and cost of the system on the other hand. In the prior art, the solutions disclosed in the patents related to space printing are only used for FDM printing methods, applicable materials are nonmetal, and there is no printing method and device available for metal materials. In addition, although these methods all use the rotation around the center to generate a centrifugal force, there is no implementation strategy for the printing of arc material adding printing, and the effect of the centrifugal force on improving the forming quality of metal material additive manufacturing is not revealed.

Therefore, how to change the current situation that is difficult to control the forming speed and forming quality of additive manufacturing in a microgravity environment remains to be a problem to be solved.

### SUMMARY

An example practical application of the disclosed subject matter is to provide a metal additive manufacturing device, to control the forming speed of additive manufacturing in a microgravity environment, and to improve the forming quality.

To achieve the foregoing and other practical applications, certain examples of the disclosed subject matter may be used to provide one or more of the following technical solutions:

According to one aspect of the disclosed technology, the disclosed subject matter can provide a metal additive manufacturing device, including a base, a rotating shaft, a rotating arm, working bin modules, a power module and a working medium filtration and circulation module, wherein the rotating shaft can be rotatably disposed on the base, the rotating arm can be connected to the rotating shaft, an included angle can be formed between the axis of the rotating arm and the axis of the rotating shaft, and the two working bin modules can be disposed at two ends of the rotating arm respectively; the working bin module can include a protective bin, and a workbench, a driving mechanism, a substrate and a wire feeding mechanism which are all disposed in the protective bin; the protective bin can be connected to the rotating arm; the substrate can be disposed on the workbench; the driving mechanism can drive the workbench to move in a plane perpendicular to the axis of the rotating arm; the wire feeding mechanism can be slidably connected to the protective bin; relative sliding directions of the wire feeding mechanism and the protective bin can be parallel to the axis of the rotating arm; the wire feeding mechanism can store and convey a metal wire and is disposed on one side of the substrate close to the rotating shaft; the number of the wire feeding mechanisms can be one or two; when the number of the wire feeding mechanism is one, the metal wire of the wire feeding mechanism can be connected to a first end of the power module, and the substrate can be connected to a second end of the power module; when the number of the wire feeding mechanisms is two, there can be a gap between the two wire feeding mechanisms; the metal wires of the two wire feeding mechanisms can be connected to both ends of the power module so that a loop can be formed; and the working medium filtration and circulation module can be respectively communicated with the protective bin and can convey a working medium to the protective bin or extract the working medium from the protective bin.

In some embodiments, the axis of the rotating shaft can be perpendicular to the axis of the rotating arm.

In some embodiments, the power module and the working medium filtration and circulation module can be disposed in the base, a conductive ring can be disposed at the rotating shaft, the power module can be connected to the working bin module through the conductive ring, and the working medium filtration and circulation module can be connected to the working bin module through a rotating joint.

In some embodiments, the driving mechanism can also include a rotating shaft, the rotating shaft can be connected to the workbench, the rotating shaft can drive the workbench to rotate around a first axis and a second axis, the first axis can be perpendicular to the second axis, and the first axis and the second axis can be perpendicular to the axis of the rotating arm respectively.

In some embodiments, the wire feeding mechanism can include a wire storage disk and a conveying roller, the wire storage disk can store metal wires, the wire storage disk can rotate to convey the metal wires to the conveying roller, and the conveying roller can drive the metal wires to move.

In some embodiments, the length of the rotating arm can be adjusted, the rotating arm can have a split structure, the rotating arm can include a connecting section, a first section and a second section, the connecting section can be connected to the rotating shaft, and the first section and the second section can be movably connected to both ends of the connecting section respectively.

In some embodiments, the first section and the second section can respectively be configured as sleeves of the connecting section, and the first section and the second section can be respectively slidably connected to the connecting section; locking knobs can be disposed between the first section and the connecting section and between the second section and the connecting section, and the locking knobs can fix the relative positions of the first section and the connecting section and the relative positions of the second section and the connecting section.

In some embodiments, sliding rails can be disposed between the first section and the connecting section, and between the second section and the connecting section.

In some embodiments, the protective bin can have a split structure; the protective bin can include a bin door and a bin body, the bin body can be connected to the rotating arm, the bin door can be hingedly connected to the bin body, and a sealing element can be disposed between the bin door and the bin body.

In some embodiments, the working medium transmitted by the working medium filtration and circulation module can be gas or fluid, can have low conductivity and can be subjected to discharge and breakdown in high electric field intensity.

Certain examples of the disclosed subject matter may be used to provide one or more of the following technical aspects.

In some examples, the metal additive manufacturing device disclosed herein can include a base, a rotating shaft, a rotating arm, working bin modules, a power module and a working medium filtration and circulation module, wherein the rotating shaft can be rotatably disposed on the base, the rotating arm can be connected to the rotating shaft, an included angle can be formed between the axis of the rotating arm and the axis of the rotating shaft, and the two working bin modules can be disposed at two ends of the rotating arm respectively; the working bin module can include a protective bin, and a workbench, a driving mechanism, a substrate and a wire feeding mechanism which are all disposed in the protective bin; the protective bin can be connected to the rotating arm; the substrate can be disposed on the workbench; the driving mechanism can drive the workbench to move in a plane perpendicular to the axis of the rotating arm; the wire feeding mechanism can be slidably connected to the protective bin; relative sliding directions of the wire feeding mechanism and the protective bin can be parallel to the axis of the rotating arm; the wire feeding mechanism can store and convey a metal wire and is disposed on one side of the substrate close to the rotating shaft; the number of the wire feeding mechanisms can be one or two; when the number of the wire feeding mechanism is one, the metal wire of the wire feeding mechanism can be connected to a first end of the power module, and the substrate can be connected to a second end of the power module; when the number of the wire feeding mechanisms is two, there can be a gap between the two wire feeding mechanisms; the metal wires of the two wire feeding mechanisms can be connected to both ends of the power module so that a loop can be formed; and the working medium filtration and circulation module can be respectively communicated with the protective bin and can convey a working medium to the protective bin or extract the working medium from the protective bin. When the metal additive manufacturing device disclosed herein is in operation, the wire feeding mechanism in the protective bin can convey the metal wire toward the substrate, the working medium filtration and circulation module can convey the working medium into the protective bin, and the wire feeding mechanism can be connected to the power module; when the number of the wire feeding mechanism is one, an arc generating area can be formed between the metal wire and the substrate; the arc can be used as a heat source to melt the metal wire, and the metal wire can be heated to form droplets; the rotating shaft can drive the rotating arm to rotate, the working bin modules can be disposed at both ends of the rotating arm, the droplets formed by the melting of the metal wire can fly away from a melting area under the action of a centrifugal force, and the droplets can reach the substrate, cool and solidify, and crystallize; when the number of the wire feeding mechanisms is two, the working medium between the two metal wires can be broken down, and plasma can be generated and maintained; under the action of high temperature of the plasma, the metal wires can quickly melt to form the metal droplets; the metal droplets can be accelerated by the action of the centrifugal force and fly towards the substrate in the direction of the centrifugal force; after reaching the substrate or the surface of a machined workpiece, the metal droplets can expand, and crystallize and solidify; and by controlling the relative positions of the wire feeding mechanism and the workpiece, a desired metal member can be obtained under the control of a predetermined track. By controlling the rotating speed of the rotating shaft and the length of the rotating arm, the centrifugal force can be controlled, and the magnitude of the centrifugal force can be controlled according to the predetermined track and the number of stacked layers, so as to achieve the effects of strengthening the material strength and reducing air holes and deformation, improve the additive manufacturing efficiency and the workpiece quality in a common gravity environment, and solve the problem noted above.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other aspects and features of the disclosed technology will become more apparent from the following detailed description, which proceeds with reference to the accompanying figures.

### BRIEF DESCRIPTION OF THE DRAWINGS

To describe the technical solutions in the embodiments of the disclosed subject matter more clearly, the following briefly introduces the accompanying drawings required for describing the embodiments. The accompanying drawings in the following description show merely some example embodiments of the disclosed subject matter, and a person of ordinary skill in the art may still derive other accompanying drawings from these accompanying drawings following the same principles disclosed herein.

FIG. 1 is a schematic structural diagram of a metal additive manufacturing device according to one example embodiment of the disclosed technology; and

FIG. 2 is a working flow chart of a metal additive manufacturing device according to one example embodiment of the disclosed technology.

The displayed reference numbers respectively represent:

1. base, 2. rotating shaft, 3: rotating arm, 4: working bin module, 5: power module, 6: working medium filtration and circulation module, 7: protective bin, 8: workbench, 9: substrate, 10: wire feeding mechanism, 11: control module.

### DETAILED DESCRIPTION

The following describes examples of the disclosed subject matter with reference to accompanying drawings. The described examples are merely representative rather than all possible embodiments of the disclosed subject matter.

According to one aspect of the disclosed subject matter, a metal additive manufacturing device is provided to control the forming speed of additive manufacturing in a microgravity environment, and to improve the forming quality.

The disclosed subject matter is described in further detail below with reference to the accompanying drawings and detailed embodiments.

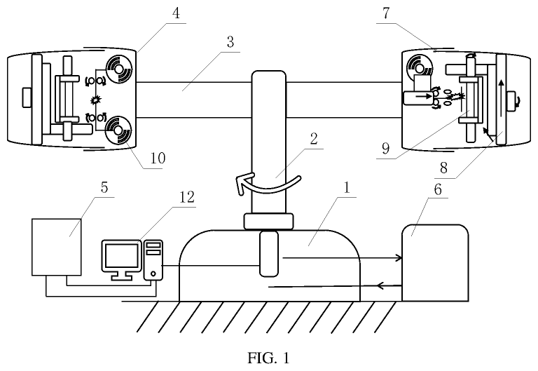

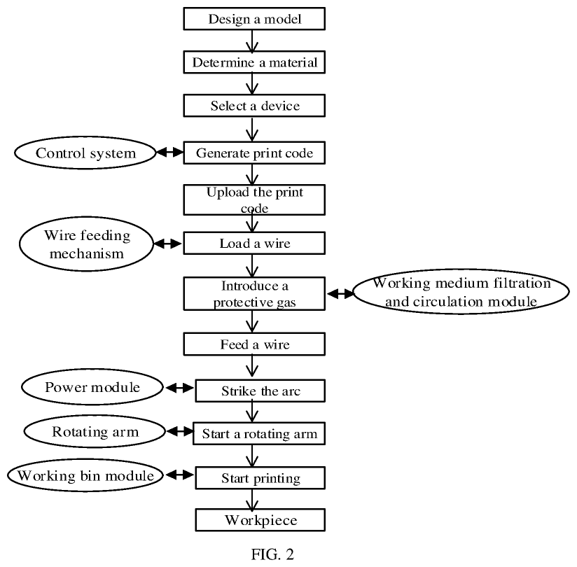

Referring to FIGS. 1-2. FIG. 1 is a schematic structural diagram of a metal additive manufacturing device according to the one example embodiment of the disclosed subject matter; and FIG. 2 is a working flow chart of a metal additive manufacturing device according to the one example embodiment of the disclosed subject matter.

As shown, the metal additive manufacturing device can include a base 1, a rotating shaft 2, a rotating arm 3, working bin modules 4, a power module 5 and a working medium filtration and circulation module 6, wherein the rotating shaft 2 can be rotatably disposed on the base 1, the rotating arm 3 can be connected to the rotating shaft 2, an included angle can be formed between the axis of the rotating arm 3 and the axis of the rotating shaft 2, and the two working bin modules 4 can be disposed at two ends of the rotating arm 3 respectively; the working bin module 4 can include a protective bin 7, and a workbench 8, a driving mechanism, a substrate 9 and a wire feeding mechanism 10 which are all disposed in the protective bin 7; the protective bin 7 can be connected to the rotating arm 3; the substrate 9 can be disposed on the workbench 8; the driving mechanism can drive the workbench 8 to move in a plane perpendicular to the axis of the rotating arm 3; the wire feeding mechanism 10 can be slidably connected to the protective bin 7; relative sliding directions of the wire feeding mechanism 10 and the protective bin 7 can be parallel to the axis of the rotating arm 3; the wire feeding mechanism 10 can store and convey a metal wire, and the wire feeding mechanism 10 can be disposed on one side of the substrate 9 close to the rotating shaft 2; the number of the wire feeding mechanisms 10 can be one or two; when the number of the wire feeding mechanism 10 is one, the metal wire of the wire feeding mechanism 10 can be connected to a first end of the power module 5, and the substrate 9 can be connected to a second end of the power module 5 (here the first end and the second end of the power module 5 each refers to the anode or the cathode of the power module 5); when the number of the wire feeding mechanisms 10 is two, there can be a gap between the two wire feeding mechanisms 10; the metal wires of the two wire feeding mechanisms 10 can be connected to both ends of the power module 5 so that a loop can be formed; the working medium filtration and circulation module 6 can be respectively communicated with the protective bin 7, and the working medium filtration and circulation module 6 can convey a working medium to the protective bin or extract the working medium from the protective bin 7.

When the metal additive manufacturing device provided by the disclosed subject matter is in operation, the wire feeding mechanism 10 in the protective bin 7 can convey the metal wire toward the substrate 9, the working medium filtration and circulation module 6 can convey the working medium into the protective bin 7, and the wire feeding mechanism 10 can be connected to the power module 5; when the number of the wire feeding mechanism 10 is one, an arc generating area can be formed between the metal wire and the substrate 9; the arc can be used as a heat source to melt the metal wire, and the metal wire can be heated to form droplets; the rotating shaft 2 can drive the rotating arm 3 to rotate, the working bin modules 4 can be disposed at both ends of the rotating arm 3, the droplets formed by the melting of the metal wire can fly away from a melting area under the action of a centrifugal force, and the droplets can reach the substrate 9, cool and solidify, and crystallize; when the number of the wire feeding mechanisms 10 is two, the working medium between the two metal wires can be broken down, and plasma can be generated and maintained; under the action of high temperature of the plasma, the metal wires can quickly melt to form the metal droplets; the metal droplets can be accelerated by the action of the centrifugal force and fly towards the substrate 9 in the direction of the centrifugal force; after reaching the substrate 9 or the surface of a machined workpiece, the metal droplets can expand, and crystallize and solidify; and by controlling the relative positions of the wire feeding mechanism 10 and the machined workpiece, a desired metal member can be obtained under the control of a predetermined track. When the number of the wire feeding mechanisms 10 is two, metal wires made of different materials can be used, the deposition speeds of the two materials can be changed by controlling the polarity and current magnitude of a power supply connected to the two metal wires, so that required workpiece material compositions and performances are acquired, customization of the material composition, structure and performance of different parts can be achieved, and 4D printing can be achieved. In other embodiments of the disclosed subject matter, the two metal wires may be connected to the same polarity of the power module 5 while the substrate 9 can be connected to the other polarity to form plasma arcs between each of the metal wires and the workbench 8, to carry out material adding processing respectively, thereby achieving additive manufacturing of dissimilar metal materials in different areas. It should be noted that metal wires can be added materials, and do not refer to a specific metal material in particular. In addition, the power module 5 can adopt a direct current power supply, which outputs a direct current or a pulsed direct current, the voltage can be adjustable between 10 V and 100 V, the output current can be adjustable between 1 A and 1000 A, and the pulse width of the pulsed direct current can be adjustable between 100 μs and 10 s or can be a continuous long pulse. When the number of the wire feeding mechanism 10 is one, an auxiliary electrode can be disposed between the metal wire and the substrate 9, and the auxiliary electrode can be in a circle shape for the metal wire to pass through or can be disposed on one side of the metal wire. Moreover, in order to facilitate control, the device can also be provided with a control module 11, which can control and detect a working state of the device and improve the automation degree of the device. In addition, the rotating shaft 2 can be provided with the driving mechanism which can be in transmission connection with the rotating shaft 2 to drive the rotating shaft 2 to rotate.

In an example embodiment, the axis of the rotating shaft 2 can be perpendicular to the axis of the rotating arm 3, which can facilitate the calculation of the centrifugal force of the control device.

In some embodiments, the power module 5 and the working medium filtration and circulation module 6 can be disposed in the base 1, a conductive ring can be disposed at the rotating shaft 2, and the power module 5 can be connected to the working bin module 4 through the conductive ring, so as to prevent the normal work of the power module 5 from being influenced when the rotating shaft 2 rotates. The working medium filtration and circulation module 6 can be connected to the working bin module 4 through a rotating joint, the working medium filtration and circulation module 6 can be communicated with the protective bin 7 through an air passage, and the working medium can be circularly conveyed into the protective bin 7. As will be readily understood to one of ordinary skill in the art having the benefit of the present disclosure, any type of the working medium that is known to those of ordinary skill in the art can be used.

In some embodiments, the driving mechanism can also include a rotating shaft, the rotating shaft can be connected to the workbench 8, the rotating shaft can drive the workbench 8 to rotate around a first axis and a second axis, the first axis can be perpendicular to the second axis, the first axis and the second axis can be perpendicular to the axis of the rotating arm 3 respectively, the rotating shaft can drive the workbench 8 to rotate, and the wire feeding mechanism 10 can move in the direction parallel to the axis of the rotating arm 3, so that the working bin module 4 can have multi-axis linkage capability, and the forming quality of the device can be improved.

In some embodiments, the wire feeding mechanism 10 can include a wire storage disk and a conveying roller, wherein the wire storage disk can store metal wires, the metal wires can be wound around the wire storage disk, the wire storage disk can rotate to convey the metal wires to the conveying roller, and the conveying roller can drive the metal wires to move and continuously carry out the forming process. In order to limit the feeding direction of the metal wire, the wire feeding mechanism 10 can also be provided with a stopper, which can limit the wire discharging direction of the metal wire and ensure that the metal wire is transported to the arc generating area.

In some embodiments, to control the centrifugal force, the length of the rotating arm 3 can be adjusted. The rotating arm 3 can have a split structure. The rotating arm 3 can include a connecting section, a first section and a second section, wherein the connecting section can be connected to the rotating shaft 2, and the first section and the second section can be movably connected to both ends of the connecting section, respectively.

In some embodiments, the first section and the second section can be respectively configured as sleeves of the connecting section, and the first section and the second section can be respectively slidably connected to the connecting section. An operator can conveniently adjust the relative positions of the first section and the connecting section and the relative positions of the second section and the connecting section, thereby changing the length of the rotating arm 3. In order to avoid slippage and dislocation between the first section and the connecting section and between the second section and the connecting section in the rotating process of the rotating arm 3, the first section and the connecting section can be in slippage and dislocation with the connecting section, locking knobs can be disposed between the first section and the connecting section and between the second section and the connecting section, the locking knobs can fix the relative positions of the first section and the connecting section and the relative positions of the second section and the connecting section, and the stability and reliability of the device can be improved.

In some embodiments, sliding rails can be disposed between the first section and the connecting section, and between the second section and the connecting section, so that the relative positions of the first section and the connecting section and the relative positions of the second section and the connecting section can be adjusted conveniently, and the work burden over the operator can be reduced.

In some embodiments, the protective bin 7 can have a split structure. The protective bin 7 can include a bin door and a bin body, wherein the bin body can be connected to the rotating arm 3; the bin door can be hingedly connected to the bin body to facilitate the opening of the bin door; a lock catch can be disposed between the bin door and the bin body to improve the stability of the working bin module 4 when rotating with the rotating arm 3; and a sealing element can be disposed between the bin door and the bin body to improve air tightness and avoid medium leakage.

According to the metal additive manufacturing device disclosed herein, the working medium filtration and circulation module 6 can convey the working medium into the protective bin 7, and the wire feeding mechanism 10 can be connected to the power module 5; when the number of the wire feeding mechanism 10 is one, an arc generating area can be formed between the metal wire and the substrate 9; the arc can be used as a heat source to melt the metal wire, and the metal wire can be heated to form droplets; the rotating shaft 2 can drive the rotating arm 3 to rotate, the working bin modules 4 can be disposed at both ends of the rotating arm 3, the droplets formed by the melting of the metal wire can fly away from a melting area under the action of a centrifugal force, and the droplets can reach the substrate 9, cool and solidify, and crystallize; when the number of the wire feeding mechanisms 10 is two, the working medium between the two metal wires can be broken down, and plasma can be generated and maintained; under the action of high temperature of the plasma, the metal wires can quickly melt to form the metal droplets; the metal droplets can be accelerated by the action of the centrifugal force and fly towards the substrate 9 in the direction of the centrifugal force; after reaching the substrate 9 or the surface of a machined workpiece, the metal droplets can expand, and crystallize and solidify; and by controlling the relative positions of the wire feeding mechanism 10 and the workpiece, a desired metal member can be obtained under the control of a predetermined track. According to the disclosed subject matter, by combining the high-temperature melting of metal wires by arcs and droplet separation speed control by the centrifugal force, the problem of metal additive manufacturing in a microgravity environment can be solved, the grain size of the structure can be improved in the solidification process, the discharge of internal mediums can be facilitated, a higher-quality material structure can be obtained, the additive manufacturing efficiency and workpiece quality in an ordinary gravity environment can be improved, and the technical challenge to control the forming speed and quality of additive manufacturing in a microgravity environment can be overcome.

Several examples are used for illustration of the principles and implementation methods of the disclosed subject matter. The description of the embodiments is used to help illustrate the method and its core principles of the disclosed subject matter. In addition, as will be readily understood by one of ordinary skill in the art having the benefit of the present disclosure, various modifications can be made in terms of specific embodiments and scope of application in accordance with the teachings of the disclosed subject matter.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

What is claimed is:

1. A metal additive manufacturing device, comprising:
a base, a rotating shaft, a rotating arm, working bin modules, a power module and a working medium filtration and circulation module;
wherein the rotating shaft is rotatably disposed on the base, the rotating arm is connected to the rotating shaft, an included angle is formed between the axis of the rotating arm and the axis of the rotating shaft, and the two working bin modules are disposed at two ends of the rotating arm respectively;
wherein the working bin module comprises a protective bin, and a workbench, a driving mechanism, a substrate and a wire feeding mechanism which are all disposed in the protective bin;
wherein the protective bin is connected to the rotating arm, the substrate is disposed on the workbench; the driving mechanism is configured to drive the workbench to move in a plane perpendicular to the axis of the rotating arm, the wire feeding mechanism is slidably connected to the protective bin, relative sliding directions of the wire feeding mechanism and the protective bin are parallel to the axis of the rotating arm;
wherein the wire feeding mechanism is configured to store and convey a metal wire and is disposed on one side of the substrate close to the rotating shaft, the number of the wire feeding mechanisms is one or two;
wherein when the number of the wire feeding mechanism is one, the metal wire of the wire feeding mechanism is connected to a first end of the power module, and the substrate is connected to a second end of the power module;
wherein when the number of the wire feeding mechanisms is two, there is a gap between the two wire feeding mechanisms; the metal wires of the two wire feeding mechanisms are connected to both ends of the power module so that a loop is formed; and
wherein the working medium filtration and circulation module is respectively communicated with the protective bin and configured to convey a working medium to the protective bin or extract the working medium from the protective bin.

2. The metal additive manufacturing device according to claim 1, wherein the axis of the rotating shaft is perpendicular to the axis of the rotating arm.

3. The metal additive manufacturing device according to claim 1, wherein the power module and the working medium filtration and circulation module are disposed in the base, a conductive ring is disposed at the rotating shaft, the power module is connected to the working bin module through the conductive ring, and the working medium filtration and circulation module is connected to the working bin module through a rotating joint.

4. The metal additive manufacturing device according to claim 1, wherein the driving mechanism further comprises a rotating shaft, the rotating shaft is connected to the workbench, the rotating shaft is configured to drive the workbench to rotate around a first axis and a second axis, the first axis is perpendicular to the second axis, and the first axis and the second axis are perpendicular to the axis of the rotating arm, respectively.

5. The metal additive manufacturing device according to claim 1, wherein the wire feeding mechanism comprises a wire storage disk and a conveying roller, the wire storage disk is configured to store metal wires, the wire storage disk is configured to rotate to convey the metal wires to the conveying roller, and the conveying roller is configured to drive the metal wires to move.

6. The metal additive manufacturing device according to claim 1, wherein the length of the rotating arm is adjustable, the rotating arm has a split structure, the rotating arm comprises a connecting section, a first section and a second section, the connecting section is connected to the rotating shaft, and the first section and the second section are movably connected to both ends of the connecting section, respectively.

7. The metal additive manufacturing device according to claim 6, wherein the first section and the second section are respectively configured as sleeves of the connecting section, and the first section and the second section are respectively slidably connected to the connecting section; wherein locking knobs are disposed between the first section and the connecting section and between the second section and the connecting section, and the locking knobs are configured to fix the relative positions of the first section and the connecting section and the relative positions of the second section and the connecting section.

8. The metal additive manufacturing device according to claim 7, wherein sliding rails are disposed between the first section and the connecting section, and between the second section and the connecting section.

9. The metal additive manufacturing device according to claim 1, wherein the protective bin has a split structure, the protective bin comprises a bin door and a bin body, the bin body is connected to the rotating arm, the bin door is hingedly connected to the bin body, and a sealing element is disposed between the bin door and the bin body.

10. The working medium according to claim 1, wherein the working medium transmitted by the working medium filtration and circulation module is gas or fluid, has low conductivity and are configured to be subject to discharge and breakdown in high electric field intensity.
